(19) United States
(12) Patent Application Publication
(10) Pub. No.: US 2009/0259974 A1
(43) Pub. Date: Oct. 15, 2009

(54) METHOD AND APPARATUS FOR DISPLAYING CONTENT MENUS IN A MOBILE DEVICE

(75) Inventor: Keng-Chung Lin, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/101,301

(22) Filed: Apr. 11, 2008

(51) Int. Cl. G06F 3/048

(52) U.S. Cl. 715/840

(57) ABSTRACT

A display method for displaying content menus for use in a mobile device is disclosed. The method comprises the following steps. First, a user request is received. Second, display brief of actual data is acquired from an entry of an index file of a non-volatile storage medium according to the user request. Thereafter, a content menu comprising a menu item with the display brief is generated. Then, the generated content menu is displayed, wherein the entry further comprises information pointing to a location which the actual data stores in the non-volatile storage medium, the display brief is a reduced form of the actual data, and the actual data is displayed when the menu item is selected.

### BACKGROUND OF THE INVENTION

1. Field of the Invention

The invention relates to menus display in a mobile device, and more particularly, to methods and apparatuses for efficiently displaying content (e.g. short message service (SMS), still image, video file) menus so as to reduce menu display time and unnecessary access of the subscriber identity module (SIM) or universal subscriber identity module (USIM) card in a mobile device.

2. Description of the Related Art

Recently, SIM/USIM information has been extensively utilized for authentication, authorization and accounting in wireless telephony networks. SIM/USIM cards can also be programmed to display custom menus for personalized services. To get a mobile device ready, some data stored in the SIM card must be retrieved. For example, during the power on stage, number of messages and associated message information therewith, such as folder identification, number, and read/unread/sent/unsent statuses, stored in the SIM, have to be known first so as to construct a corresponding table before accessing an SMS folder. However, since Mass SIM/USIM may support thousands of messages, it takes an incredibly long amount of time to scan the whole storage each time to list/sort SMS items of one page in one folder. Therefore, it takes too much time to load all messages in Mass SIM/USIM each time when accessing an SMS folder.

### BRIEF SUMMARY OF THE INVENTION

An embodiment of the invention provides a display method for displaying content menus for use in a mobile device. The method comprises the following steps. First, a user request is received. Second, display brief of actual data is acquired from an entry of an index file of a non-volatile storage medium according to the user request. Thereafter, a content menu comprising a menu item with the display brief is generated. Then, the generated content menu is displayed, wherein the entry further comprises information pointing to a location which the actual data stores in the non-volatile storage medium, the display brief is a reduced form of the actual data, and the actual data is displayed when the menu item is selected.

An embodiment of the invention also provides a mobile device for displaying content menus. The mobile device comprises a display device, a non-volatile storage medium and a processor. The non-volatile storage medium stores actual data and an index file storing an entry comprising display brief of the actual data and information pointing to a location which the actual data stores. The processor receives a user request, acquires the display brief of the actual data from the entry of the index file according to the user request, generates a content menu comprising a menu item with the display brief and displays the generated content menu on the display device.

### BRIEF DESCRIPTION OF THE DRAWINGS

The invention can be more fully understood by reading the subsequent detailed description and examples with reference to the accompanying drawings, wherein:

FIG. 1 illustrates an exemplary architecture of a mobile device;

FIG. 2 is a schematic diagram illustrating an embodiment of an index file;

FIG. 3 is a flowchart illustrating an exemplary process for displaying a content menu, performed by the processor, according to the invention;

FIG. 4 is a flowchart illustrating another exemplary process for displaying a content menu, performed by the processor, according to the invention;

FIG. 5 is a schematic diagram illustrating the format of an embodiment of an index file according to the invention;

FIG. 6A is a schematic diagram illustrating the format of an embodiment of an index file for an SMS message according to the invention;

FIG. 6B is a schematic diagram illustrating the format of an embodiment of an index file for a still image file or a video file according to the invention;

FIG. 7 is a flowchart illustrating an exemplary generation process of an index file, performed by the processor, according to the invention; and

FIG. 8 is a flowchart illustrating an exemplary process for displaying a content menu, performed by the processor, according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

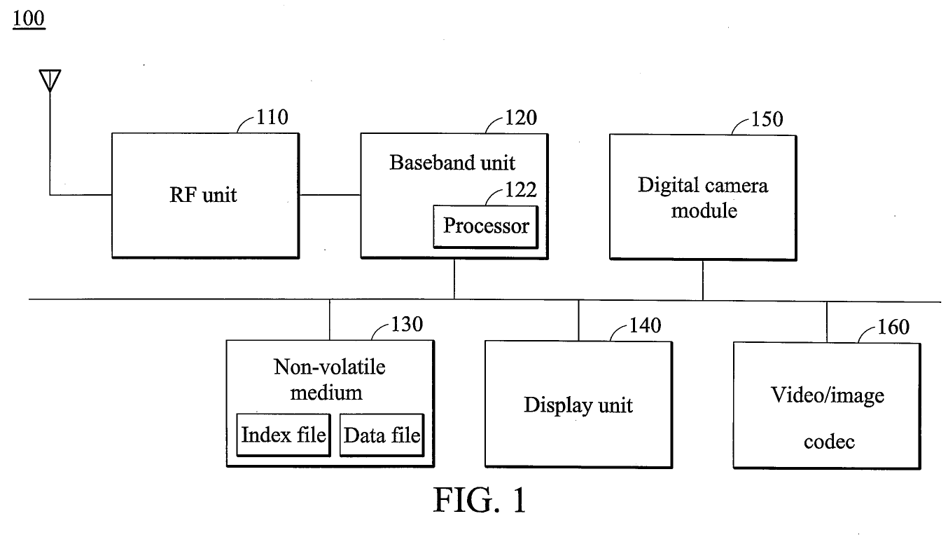

The invention is now described with reference to FIGS. 1 through 8, which generally relate to menus display in a mobile device. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide methods and apparatuses for displaying content menus for use in a mobile device. By utilizing index files during displaying, wherein each has a display brief, the time needed for decoding and displaying the content menu can be significantly reduced due to elimination of subscriber identity module (SIM) or universal subscriber identity module (USIM) card access for retrieving the data files.

FIG. 1 illustrates an exemplary architecture of a mobile device 100. The mobile device 100 comprises an RF unit 110, a baseband unit 120, a non-volatile storage medium 130, a display unit 140, a video/image codec 150 and a digital camera module 160. The RF unit 110 performs functions including for example, modulation/demodulation, to transmit and receive RF signals to and from a network (not shown). The received RF signals are then down-converted to baseband signals by the baseband unit 120 for use in the mobile device 102. A processor 122 within the baseband unit 120 performs operations of the mobile device 100 including display of content menus. The non-volatile storage medium 130 stores actual data and index files. The non-volatile storage medium 130 is capable of keeping data even if the power of the mobile device is removed. The non-volatile storage medium 130 may be an SIM/USIM card or any external removable storage device (e.g. SD/CF/MMC flash card) that communicates with the mobile device through a corresponding connecting interface (not shown) provided by the mobile device. The SIM/USIM generally includes a processor and memory for storing information. In order to identify the mobile user, SIM/USIM contains some network specific information, such as an International Mobile Subscriber Identity (IMSI), ICCID, Authentication Key (Ki) and Local Area Identity (LAI), for authenticating and identifying mobile devices on the network. By using the SIM/USIM card, a user can have access to any and all of his/her subscribed services.

The processor 122 interfaces with the display unit 140 to display received information, stored information, user inputs, and the like. An input device (not shown), which may be a telephone type keypad or full alphanumeric keyboard, is normally provided for receiving signals indicating data accessing or storage in mobile device 100, information for transmission to the network, a telephone number to place a telephone call, commands to be executed on mobile device 100, and possibly other or different user inputs.

The digital camera module 160 is capable of capturing video or image data when being enabled. The captured video or image data is then encoded or decoded by the video/image codec 150 to generate a standard format image file (such as an image file in the JPEG format and a video file in the AVI or MPEG format). The generated video/image files are stored in the SIM/USIM card for future retrieving.

With the increased storage capacity of the SIM/USIM card, thousands of records or files such as short messages, digital still images, video files or others can be stored. To display a content menu containing menu items, each corresponding to a specific record or file, on the display unit 140, the processor 122 searches and accesses the stored records or files from the SIM/USIM card, and then, parses the content thereof to extract display brief of menu items, such as partial short messages, reduced still images, video clips or others. Such access consumes excessive time and hinders the efficiency when displaying the content menu on the display unit 140.

In one embodiment, an index file is designed for reading short message service (SMS) or multimedia message service (MMS) messages from the SIM/USIM card.

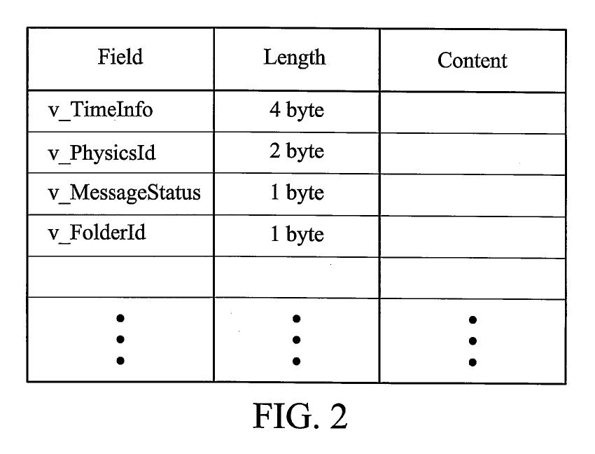

FIG. 2 is a schematic diagram illustrating an embodiment of an index file. Referring to FIG. 2, the index file comprises fields regarding an SMS/MMS message (such as fields v_Timeinfo, v_Physicsld, v_MessageStatus or the v_FolderID), where the field v_Timeinfo of 4 bytes represents a specific time when storing the SMS/MMS message, the field v_Physicsld of 2 bytes indicates a physical location storing the SMS/MMS message in the SIM/USIM card, the field v_MessageStatus of 1 byte indicates statuses of the SMS/MMS message (e.g. read/unread/sent/unsent), and the field v_Folderld of 1 byte indicates a folder to store the SMS/MMS message, where the folder is identified by a file system. The actual data of the SMS/MMS message is stored in a specific location indicated by the field v_Physicsld of the index file 200.

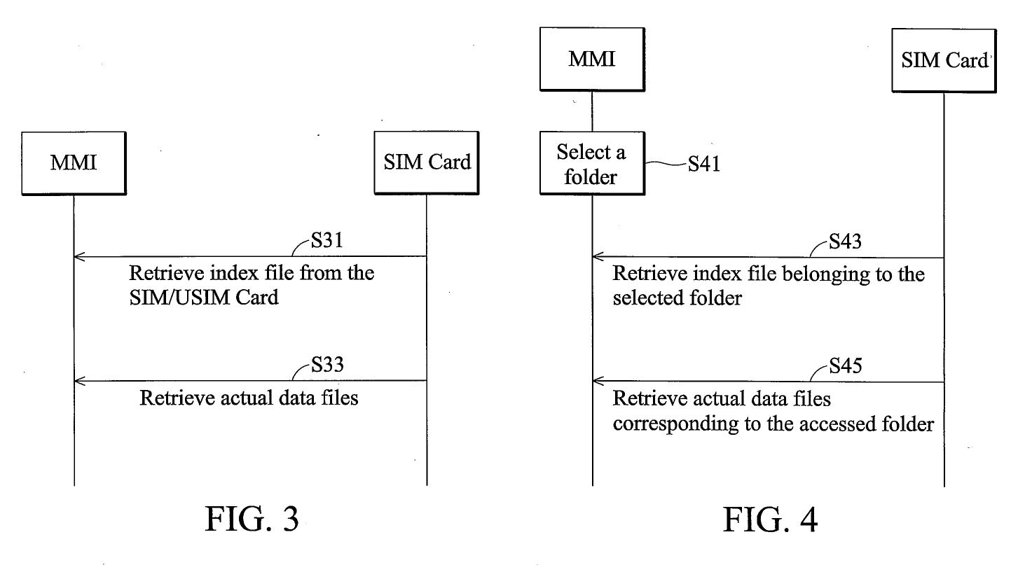

FIG. 3 is a flowchart illustrating an exemplary process for displaying a content menu, performed by the processor (e.g. 122 of FIG. 1), according to the invention. An SIM/USIM card stores an index file and multiple SMS messages, and each SMS message is pointed and characterized by an index file. Since an SMS message packet is limited to 140-160 bytes for transmitting, a large SMS message may be divided into several segments to be transmitted in sequence. In this case, a serial number representing the order of each divided segment of the whole SMS message may be provided during reconstruction by the receiver (i.e. mobile device). When receiving all segments of the SMS message, the mobile device needs to spend some time to unpack and rearrange the segments in order by referring the serial number thereof to acquire the SMS message. An MMI module (not shown) within the mobile device interacts with the SIM card to access the index file and data files storing SMS messages. In step S31, the MMI module retrieves the index file from the SIM card to obtain information indicating how many SMS messages are stored in the SIM card. Then, in step S33, actual data files are retrieved in sequence by referring entries of the index file in order to obtain display brief required to be displayed with corresponding menu items of the content menu.

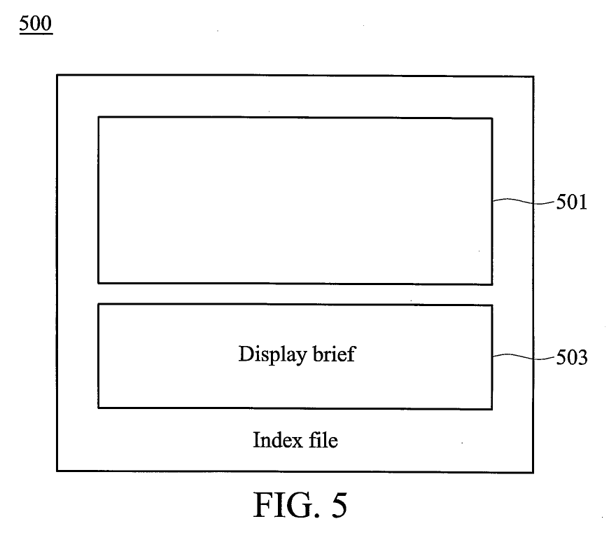

FIG. 4 is a flowchart illustrating another exemplary process for displaying a content menu, performed by the processor (e.g. 122). In this embodiment, it is assumed that the content menu to be displayed is an SMS menu with at least inbox and outbox folders in which the inbox folder of the SMS menu records the incoming SMS messages while the outbox folder records the outgoing SMS messages. Since SMS messages are classified by folders for browsing, users need to enter one of the folders first (step S41). When the user accesses a specific SMS folder (such as the outbox folder or inbox folder), in step S43, an index file belonging to the selected folder is retrieved. For example, entries containing information regarding that SMS messages are belonging to the inbox folder are retrieved when the accessed SMS folder is the inbox folder. For the retrieved index file does not contain enough information for displaying the menu items, accesses of the actual data are required. Therefore, in step S45, actual data files are retrieved in sequence by referring entries of the index file so as to obtain display brief required to be displayed with corresponding menu items in the selected content menu. Once performing any operation corresponding to the SMS menu, such as updating the menu to display the previous or next page of menu items, the SIM card may be accessed again to retrieve the corresponding actual data and acquire display brief therefrom.

In the aforementioned embodiment, although the index file as shown in FIG. 2 facilitates to dynamically locate actual data with reference to address information, the processor still requires to retrieve the actual data from the SIM card to acquire display brief for displaying menu items of a selected content menu. An improved index file format is further introduced to improve efficiency.

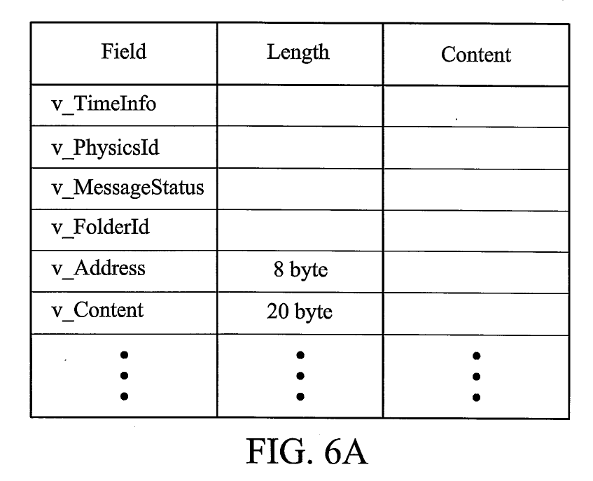

FIG. 5 is a schematic diagram illustrating the format of an embodiment of an index file 500 according to the invention. As shown, the index file 500 at least comprises a first portion 501 and a second portion 503, wherein the first portion 501 stores profile information of a corresponding data file containing actual data while the second portion 503 stores display brief corresponding to the actual data, utilized to be displayed with a corresponding menu item of the content menu for browsing. With a SMS message (actual data), the display brief may be a phone number of the sender, a partial SMS message, frequently occurred keywords of the SMS message or others. With a still image (actual data), the display brief may be a reduced image of the still image, a portion of the still image or others. With a video file (actual data), the display brief may be a video clip of two seconds, a first frame of the video file.

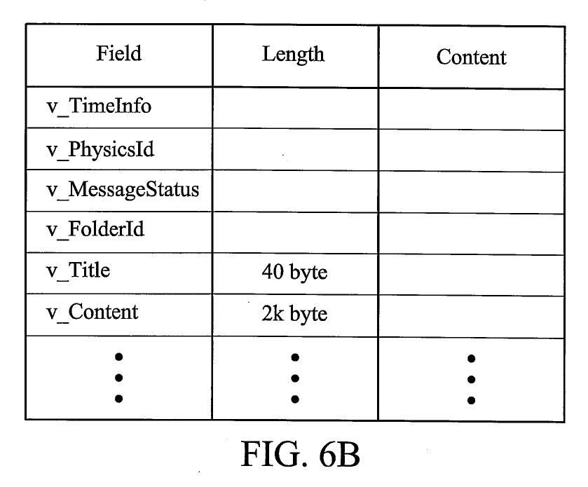

FIG. 6A is a schematic diagram illustrating the format of an embodiment of an index file for an SMS message according to the invention. Referring to FIG. 6A, the index file comprises profile fields for identifying an SMS/MMS message (such as fields v_Timeinfo, v_Physicsld, v_MessageStatus and v_FolderID) and display fields for displaying the SMS menu (such as fields v_Address and v_Content) where the field v_Timeinfo represents a specific time for storing the SMS/MMS message, the field v_Physicsld indicates a physical location storing the SMS/MMS message in the SIM/USIM card, the field v_MessageStatus indicates the statuses of the SMS/MMS message (e.g. read/unread/sent/unsent), the field v_FolderId indicates a folder to store the SMS/MMS message, the field v_Address of 8 bytes indicates a phone number of a sender sending the SMS/MMS message, and the field v_Content of 20 bytes represents the text of the first 20 bytes or frequently occurred keywords of the SMS/MMS message, for example. It is to be understood that the index file can be designed to contain similar but different display brief corresponding to SMS/MMS messages according to design requirement.

FIG. 6B is a schematic diagram illustrating the format of an embodiment of an index file 600 for a still image file or a video file according to the invention. The index file comprises profile fields for identifying the still image file or video file (such as fields v_Timeinfo, v_Physicsld, v_MessageStatus and v_FolderID) and display fields for displaying the still image or video menu (such as fields v_Title and v_Content). The field v_Title of 40 bytes indicates a filename or a title of the still image or video file, for example. The field v_Content of 2 k bytes represents a reduced image of the still image file, or a video clip or a first frame of the video file, for example. It is to be understood that the index file can be designed to contain similar but different display brief corresponding to still image or video files according to design requirement.

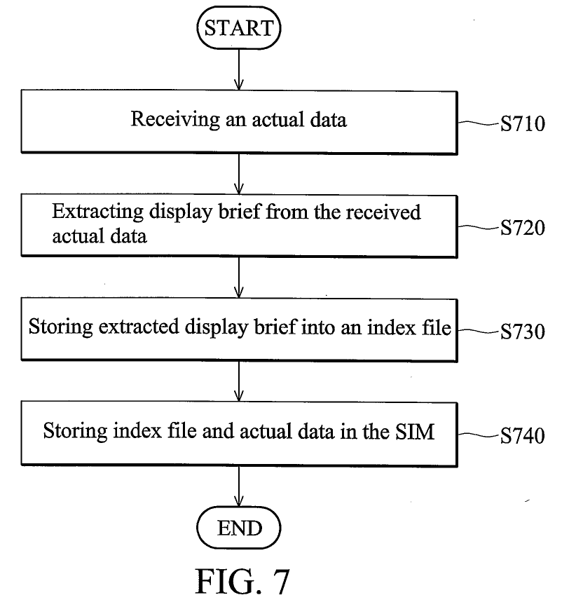

FIG. 7 is a flowchart illustrating an exemplary generation process of an index file, performed by the processor (e.g. 122), according to the invention.

In step S710, actual data (e.g. an SMS/MMS message, a still image file, a video file or others) is received by the processor 122. In step S720, display brief is extracted from the received actual data. Then, in step S730, the extracted display brief is stored into an index file (e.g. stored in the second portion 503 of the index file 500 in FIG. 5). In step S740, the index file and the actual data are stored in the SIM/USIM card.

By utilizing the index file illustrated in FIG. 6A or 6B as well as the mentioned generation process illustrated in FIG. 7, the display brief is extracted and stored in the index file when the actual data is created and stored in the SIM/USIM card.

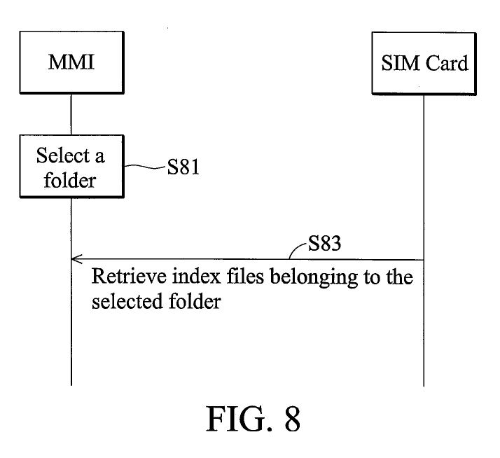

FIG. 8 is a flowchart illustrating an exemplary process for displaying a content menu, performed by the processor (e.g. 122), according to the invention. In this embodiment, it is assumed that the content menu to be displayed is an SMS menu with at least inbox and outbox folders in which the inbox folder of the SMS menu records the incoming SMS messages while the outbox folder records the outgoing SMS messages. Since SMS messages are classified by folders for browsing, users need to first enter one of the folders (step S81). When the user accesses a specific SMS folder, a user request is received. In response to the user request, in step S83, the index file belonging to the selected folder is retrieved. As the index file contain display brief, accessing of the actual data is unnecessary thereby speeding up MMI response time. Moreover, any operation such as updating the displayed menu items to display a different page of menu items, can be quickly performed. In other words, no actual data is required to be retrieved from the SIM/USIM card to construct the displayed menu. The actual data file is retrieved only when a corresponding menu item of the menu is selected by the user.

The aforementioned methods may be applied to different types of content for browsing. The content may be, for example, SMS/MMS messages, text files (e.g. electronic book), audio/video files, image files and the like.

In some embodiments, the content may be an image file or a video file acquired from the digital camera module 160. Or, the image file or video file may be acquired from an external storage medium (e.g. SD card) or from a connected network (e.g. Internet) through a corresponding connection interface (not shown) provided by the mobile device 100. When an image file with a large image size or a video file having a plurality of frames is received, a display brief is extracted therefrom. For example, a still image with 1 Mega bytes is reduced to an iconic image with 1 Kbytes as display brief. Several frames are selected from a video file as display brief. After extracting the display brief, the display brief is then recorded in the index file. The index file and the actual data (i.e. original image file or video file) are stored in the SIM/USIM card.

In some embodiments, the content may be an electronic book with numerous text. When an electronic book data is received, a display brief is extracted from the received data. The title, summary or beginning few words of the electronic book are extracted as display brief.

The described embodiments for displaying content menus, or certain aspects or portions thereof, may be practiced in logic circuits, or may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a digital camera, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A display method for displaying content menus for use in a mobile device, comprising:
receiving a user request;
acquiring display brief of actual data from an entry of an index file of a non-volatile storage medium according to the user request;
generating a content menu comprising a menu item with the display brief; and
displaying the generated content menu,
wherein the entry further comprises information pointing to a location which the actual data stores in the non-volatile storage medium, the display brief is a reduced form of the actual data, and the actual data is displayed when the menu item is selected.

2. The method of claim 1, wherein the actual data is a short message service (SMS) message, and the display brief is a portion of text of the SMS message.

3. The method of claim 1, wherein the actual data is a multimedia message service (MMS) message, and the display brief is a portion of text of the MMS message.

4. The method of claim 1, wherein the actual data is a short message service (SMS) message, and the display brief is a phone number of a sender.

5. The method of claim 1, wherein the actual data is a video file and the display brief comprises at least one frame of the video file.

6. The method of claim 1, wherein the actual data is a still image and the display brief is a reduced image of the still image.

7. The method of claim 1, wherein the actual data is a still image and the display brief is a portion of the still image.

8. The method of claim 1, further comprising:
receiving the actual data;
extracting the display brief from the actual data;
storing the actual data in the non-volatile storage medium;
storing information pointing to the location which the actual data stores in the entry of the index file; and
storing the extracted display brief in the entry of the index file.

9. The method of claim 1, wherein the non-volatile storage medium is a Subscriber Identity Module (SIM) or a Universal Identity Module (USIM) comprising a processor and memory storing an International Mobile Subscriber Identity for identifying the mobile device on a network.

10. A mobile device for displaying content menus, comprising:
a display device;
a non-volatile storage medium storing actual data and an index file storing an entry comprising display brief of the actual data and information pointing to a location which the actual data stores; and
a processor receiving a user request, acquiring the display brief of the actual data from the entry of the index file according to the user request, generating a content menu comprising a menu item with the display brief and displaying the generated content menu on the display device.

11. The mobile device of claim 10, wherein the actual data is a short message service (SMS) message, and the display brief is a portion of text of the SMS message.

12. The mobile device of claim 10, wherein the actual data is a multimedia message service (MMS) message, and the display brief is a portion of text of the SMS message.

13. The mobile device of claim 10, wherein the actual data is a short message service (SMS) message, and the display brief is phone number of the sender.

14. The mobile device of claim 10, wherein the actual data is a video file and the display brief comprises at least one frame of the video file.

15. The mobile device of claim 10, wherein the actual data is a still image and the display brief is a reduced image of the still image.

16. The mobile device of claim 10, wherein the actual data is a still image and the display brief is a portion of the still image.

17. The mobile device of claim 10, wherein the processor further receives the actual data, extracts the display brief from the actual data, stores the actual data in the non-volatile storage medium, stores information pointing to the location which the actual data stores in the entry of the index file and stores the extracted display brief in the entry of the index file.

18. The mobile device of claim 10, wherein the non-volatile storage medium is a Subscriber Identity Module (SIM) or a Universal Identity Module (USIM) comprising a processor and memory storing an International Mobile Subscriber Identity for identifying the mobile device on a network.
